(19) United States
(12) Patent Application Publication
(10) Pub. No.: US 2009/0206766 A1
(43) Pub. Date: Aug. 20, 2009

(54) HIGH-PRESSURE DISCHARGE LAMP, LIGHTING APPARATUS AND HIGH-PRESSURE DISCHARGE LAMP APPARATUS

(75) Inventors: Kozo Uemura, Yokosuka-Shi (JP); Masazumi Ishida, Yokosuka-Shi (JP); Hiroshi Kamata, Tokyo (JP); Takuya Honma, Yokosuka-Shi (JP)

Correspondence Address: DLA PIPER LLP US, P. O. BOX 2758, RESTON, VA, 20195, US

(73) Assignee: TOSHIBA LIGHTING & TECHNOLOGY CORPORATION, SHINAGAWA-KU (JP)

(21) Appl. No.: 12/429,759

(22) Filed: Apr. 24, 2009

Related U.S. Application Data
(63) Continuation of application No. PCT/JP2007/070938, filed on Oct. 26, 2007.

(30) Foreign Application Priority Data
Oct. 27, 2006 (JP) 2006-293056
Dec. 18, 2006 (JP) 2006-340062

(51) Int. Cl. H05B 41/16; H01J 61/16

(52) U.S. Cl. 315/246; 313/643

(57) ABSTRACT

A high-pressure discharge lamp is characterized by including a translucent airtight container having a discharging space in an internal portion, electrodes for causing discharge in the discharging space of the translucent airtight container, and an ionization medium sealed in the translucent airtight container and containing a metal halide and rare gas, the metal halide including at least one type of halides of thulium and holmium whose sealing ratio with respect to the total amount of sealed metal halides is not lower than 30 mass % and the rare gas is xenon at not lower than 3 atm at 25° C., and the high-pressure discharge lamp is characterized in that mercury and a metal halide for formation of lamp voltage are not substantially contained in the translucent airtight container.

### CROSS-REFERENCE TO RELATED APPLICATIONS

This is a Continuation Application of PCT Application No. PCT/JP2007/070938, filed Oct. 26, 2007, which was published under PCT Article 21(2) in Japanese.

This application is based upon and claims the benefit of priority from prior Japanese Patent Applications No. 2006-293056, filed Oct. 27, 2006; and No. 2006-340062, filed Dec. 18, 2006, the entire contents of both of which are incorporated herein by reference.

### BACKGROUND OF THE INVENTION

1. Field of the Invention

This invention relates to a high-pressure discharge lamp that does not essentially contain mercury, and a lighting apparatus and high-pressure discharge lamp apparatus that include such high-pressure discharge lamp.

2. Description of the Related Art

A high-pressure discharge lamp in which the sealing amount of ZnI₂, a substitute material for mercury, is regulated is known (see Jpn. Pat. Appln. KOKAI Publication No. 2003-303571).

Further, a high-pressure discharge lamp using a metal selected from a group of Na, Tl and Dy for a main luminous metal as a main component, having one type or plural types of Ho, Tm and In sealed therein as a sub-component and using a halide of Al, Zn, Fe or 0 the like as a substitute material for mercury is already known (see Jpn. Pat. Appln. KOKAI Publication No. 2004-55140).

Incidentally, in order to start the high-pressure discharge lamp, it is common to apply a high-voltage pulse between a pair of electrodes. Further, as means for generating a high-voltage pulse, it is known by those skilled in the art that a high-voltage pulse generator called an igniter is used. It is known that a high-voltage pulse generated from the high-pressure generator is prevented from being attenuated by integrating the high-voltage pulse generator with a lamp socket for the high-pressure discharge lamp and reducing the distance with respect to the high-pressure discharge lamp (see Jpn. Pat. Appln. KOKAI Publication No. 2003-158022).

Further, it is also known that a high-voltage pulse generator is integrated with a high-pressure discharge lamp (see Jpn. Pat. Appln. KOKAI Publication No. 2002-8878).

On the other hand, conventionally, as a buffer substance for formation of lamp voltage of the high-pressure discharge lamp, it is common to seal mercury. The reason for this is that mercury can permit a desired high lamp voltage to be generated and it can be started by application of a high-voltage pulse with a relatively low peak value. However, since mercury is an environmental load substance, a mercury-free high-pressure discharge lamp has been studied. Developed to date is a metal halide lamp in which substantially the same lamp voltage as that of a metal halide lamp containing mercury is obtained by adding a halide of a metal such as zinc (Zn) whose vapor pressure is high and that does not emit a large amount of visible light as a second halide instead of mercury to a first halide formed of a halide of a luminous metal (see Jpn. Pat. Appln. KOKAI Publication No. H11-238488). The technique is provided for practical use as a metal halide lamp for vehicle headlights.

Further, a technique for using a translucent ceramic as a translucent airtight container of a high-pressure discharge lamp has been developed (see Jpn. Pat. Appln. KOKAI Publication No. H6-196131). This technique is mainly provided for practical use in general illumination. Since the translucent ceramic airtight container has a heat resistance higher than a quartz glass airtight container, it is possible for the temperature of the coolest portion to be high. Further, the lamp voltage can be further raised by using a translucent ceramic airtight container for a mercury-free metal halide lamp.

However, the linear transmittance of the conventional translucent ceramic airtight container is lower than 20%. Therefore, it is difficult to be applied to, for example, a high-pressure discharge lamp for car headlights that is required to satisfy a preset light distribution characteristic by use of an optical system. However, it becomes possible to obtain a polycrystalline translucent alumina ceramic having a linear transmittance of 20% or more, which have raised expectations of applications to various high-pressure discharge lamps, such as mercury-free metal halide lamps.

A known mercury-free high-pressure discharge lamp (that is hereinafter referred to as a “mercury-free lamp” for convenience) contains a so-called second metal halide such as ZnI₂ used for formation of lamp voltage in addition to a halide of a luminous metal. In this case, a mercury-free lamp that does not contain the second metal halide is also known, but it is not practical since a practical lamp voltage cannot be attained or a special lighting state is required.

However, a problem occurs when the second metal halide such as ZnI₂ used for formation of lamp voltage is sealed within. The problem is that the moisture absorbency of the second metal halide is significant and is a main factor in the introduction of moisture as an impurity into the lamp. Therefore, the lamp service life is increased when the amount of the second metal halide such as ZnI₂ is decreased.

Further, there also occurs a problem that as the sealing amount of the second metal halide such as ZnI₂ becomes larger, cloudiness caused by a reaction between the metal halide and the translucent airtight container tends to become more significant. Therefore, the lamp service life is improved by reducing the sealing amount of the so-called second metal halide such as ZnI₂.

Further, for example, since the second halide such as ZnI₂ has a lower melting point in comparison with a halide of a luminous metal such as Tm, there occurs a problem that a pellet obtained by mixing and integrating them cannot be manufactured. Therefore, two or more types of pellets contained in the translucent airtight container will be required and the manufacturing cost will rise.

### BRIEF SUMMARY OF THE INVENTION

The inventor found that the lamp voltage could be made high and the color deviation could be reduced if a known halide of thulium (Tm) or holmium (Ho) was sealed in the translucent airtight container as a luminous metal even if a so-called second halide such as ZnI₂ and mercury were not used. This invention is made based on this discovery.

An object of this invention is to provide a high-pressure discharge lamp that has practical electrical characteristics and luminous characteristics without substantially sealing mercury and a substitute material for mercury, that is, a halide for formation of lamp voltage and in which the color deviation is small and the service life characteristic is improved, and also provide a lighting apparatus that includes this lamp.

The high-pressure discharge lamp of this invention is characterized by including a translucent airtight container having a discharging space in an internal portion, electrode means for causing discharge in the discharging space of the translucent airtight container, and an ionization medium sealed in the translucent airtight container and containing a metal halide and rare gas, the metal halide including at least one type of halides of thulium and holmium whose sealing ratio with respect to all of sealed metal halides is not lower than 30 mass % and the rare gas being xenon of 3 atm or higher at 25° C. and is characterized in that mercury and a metal halide for formation of lamp voltage are not substantially contained in the translucent airtight container.

A lighting apparatus of this invention is characterized by including a lighting apparatus main body, the high-pressure discharge lamp arranged in the lighting apparatus main body, and a lighting device that lights the high-pressure discharge lamp.

A high-pressure discharge lamp apparatus of this invention is characterized by including the high-pressure discharge lamp, a high-voltage pulse generator that generates a high-voltage pulse applied between a pair of electrodes of a luminous tube to start the high-pressure discharge lamp, and a current conducting system that connects the high-voltage pulse generator and the luminous tube of the high-pressure discharge lamp and has dielectric strength of 9 kV or more.

[Translucent Airtight Container]

In this invention, the term translucent airtight container refers to an airtight container capable of guiding visible light of a desired wavelength region generated by discharging to the exterior. The translucent airtight container can be formed of any material if it has translucency and is a fire-resistant material that is sufficiently resistant to the normal operation temperature of the lamp. For example, quartz glass or a translucent ceramic can be used. However, the translucent airtight container formed of a translucent ceramic is particularly suitable in this invention since the temperature of the coolest portion can be set high, the lamp voltage can be set high and the luminous efficiency can be enhanced. As the translucent ceramic, translucent alumina, yttrium-aluminum-garnet (YAG), yttrium oxide (YOX), or polycrystalline non-oxides, for example, a polycrystalline or single crystal ceramic such as aluminum nitride (AlN) can be used. In this case, it is permitted to form a halogen resistant or metal resistant transparent coating film on the inner surface of the airtight container or improve the quality of the inner surface of the translucent airtight container as required.

The translucency of the translucent ceramic airtight container refers to light permeability of such a degree that light generated by discharging can pass therethrough and can be guided to the exterior and may mean not only transparency but also light diffusion. Further, only the main portion of a portion that surrounds at least the discharging space is required to have translucency, and additional structures other than the main portion may have a light shielding property.

Further, the translucent airtight container has a discharging space in the internal portion thereof. In order to surround the discharging space, the translucent airtight container has a surrounding portion. The internal portion of the surrounding portion is set to a suitable shape, for example, a spherical shape, elliptic spherical shape or substantially cylindrical shape. As the volume of the discharging space, various values can be selected according to the electrode-electrode distance, rated lamp power and the like of a metal halide lamp. For example, in the case of a liquid crystal projector lamp, it can be set to 1.0 cc or less. In the case of a car headlight lamp, it can be set to 0.05 cc or less. Further, in the case of a general illumination lamp, it can be set to about 1 cc according to the rated lamp power.

In order to manufacture a translucent ceramic airtight container, it can be integrally formed with the surrounding portion or may be formed by connecting or engaging a plurality of constituent members. For example, if it has an additional structure such as a small-diameter cylindrical portion in addition to the surrounding portion, the additional structure can be integrally formed with one end or both ends of the surrounding portion from the beginning. However, for example, an integrated translucent ceramic airtight container can be formed by separately and temporarily sintering the surrounding portion and additional structure, connecting them as required and sintering the whole portion. Further, an integrated surrounding portion can be formed by separately and temporarily sintering the cylindrical portion and end plate portion, then connecting them and sintering the whole portion.

Further, it is permitted to provide a pair of sealing portions, one at either end of the surrounding portion. The pair of sealing portions are means for sealing the surrounding portion, supporting the axial portions of the electrodes and contributing to introduction of a current from the lighting circuit to the electrodes in an airtight fashion. The sealing portions are generally arranged on both ends of the surrounding portion. If the material of the airtight container is quartz glass, it is possible to use the structure in which a sealing/depositing metal foil is preferably embedded in an airtight fashion in the internal portion of the sealing portion as adequate airtight sealing conducting means in order to enclose the electrodes and introduce a current from the lighting circuit to the electrodes in an airtight fashion. In this case, the sealing/depositing metal foil is embedded in the internal portion of the sealing portion and functions as a current conducting conductor while cooperating with the sealing portion in order for the sealing portion to maintain the internal portion of the surrounding portion of the translucent airtight container in an airtight state. If the translucent airtight container is formed of quartz glass, molybdenum (Mo) is suitably used as a material of the sealing/depositing metal foil. As a method for embedding the sealing/depositing metal foil in the sealing portion, for example, a method adequately selected from a low-pressure sealing method, pinch sealing method, a combination of the above methods and the like can be used, although such method is not limited thereto.

The number of small-diameter cylindrical portions forming the structure in which the pair of general electrodes are enclosed is two. However, this number may be one to three according to the number of current conducting conductors arranged. When two opening portions are provided to enclose one pair of electrodes, the respective small-diameter cylindrical portions are arranged in separated positions. However, preferably, the pair of electrodes are separately arranged along the tube axis and face each other. In this case, the ceramic configuring the small-diameter cylindrical portion may have a light shielding property.

An intermediate member can be added to the small-diameter cylindrical portion if required. That is, it is possible to additionally use a cylindrical intermediate member that is separately provided when the translucent ceramic airtight container is formed, but integrated as a small-diameter cylindrical portion after it is enclosed together with the current conducting conductor.

On the other hand, for example, flit sealing/depositing means for pouring a flit glass between the translucent ceramic and introducing a conductor for sealing may be provided as sealing means when the translucent airtight container is formed of a translucent ceramic. Further, as an alternative sealing means, for example, a metal may be used instead of flit glass, sealing/depositing the metal and melting to-be-sealed opening portions of the translucent ceramic airtight container to directly or indirectly seal/deposit the same in the current conducting conductor. The above types of sealing means can be used as required. Further, a small-diameter cylindrical portion that communicates with the surrounding portion can be formed. This is to maintain the temperature of the coolest portion of a discharging space formed in the translucent airtight container at a desired relatively high temperature while keeping the sealing portion of the translucent airtight container at a desired relatively low temperature. If this structure is used, the sealing portion is arranged on the end portion of the small-diameter cylindrical portion and the electrode shaft is formed to extend in the small-diameter cylindrical portion to form a small gap called a capillary between the electrode shaft and the internal surface of the small-diameter cylindrical portion in the axial direction of the small-diameter cylindrical portion.

[Electrode Means]

The electrode means can be formed of a pair of electrodes enclosed in the translucent airtight container and arranged in opposition across the discharge space, for example. The electrode-electrode distance is preferably 2 mm or less for a liquid crystal projector or the like, and may be set to 0.5 mm. For a headlight, 4.2 mm is standardized as the central value. For a general illumination lamp, the electrode-electrode distance can be set to 6 mm or less for small-sized types and 6 mm or more for medium to large-sized types.

Further, the electrode is connected to a current conducting conductor that will be described later and supported in a fixed position in the translucent ceramic airtight container. For example, the base end of the electrode is connected to the end portion of the current conducting conductor that lies on the internal side of the translucent ceramic airtight container.

In addition, the electrode can be formed of an electrode main portion and/or electrode shaft portion. The electrode main portion is a portion acting as the starting point of discharge, and therefore, a portion mainly acting as a cathode and/or anode. The electrode main portion can be directly connected to the current conducting conductor without passing through the electrode shaft portion, as required. Further, in order to enlarge the surface area of the electrode main portion to attain efficient heat radiation, a tungsten coil can be wound as required and the diameter can be made larger than that of the electrode shaft portion. If the electrode has an electrode shaft portion, the electrode shaft portion is integrated or welded with the electrode main portion, protrudes backwards from the back of the electrode main portion to support the electrode main portion and is connected to the current conducting conductor. The electrode shaft portion and the end portion of the current conducting conductor can be integrated by use of single tungsten as required.

Further, as the constituent material of the electrode, a fire-resistant, conductive metal, for example, pure tungsten (W), doped tungsten containing a doping agent, thoriated tungsten containing thorium oxide, rhenium (Re) or tungsten-rhenium (W—Re) alloy can be used. The doping agent may be one type or plural types selected from a group of scandium (Sc), aluminum (Al), potassium (K) and silicon (Si).

In addition, for a small-sized lamp, a straight wire rod or a wire rod having a large-diameter portion on one end portion can be used as the electrode. For medium or large-sized electrodes, a coil formed of an electrode constituent material can be wound around an end portion of the electrode shaft. If they operate using an alternating current, the pair of electrodes have the same structure, but if they are operated by a direct current, the temperature rise in the anode is generally very high and therefore an anode having a larger heat radiation area than the cathode or a thicker main portion can be used.

Further, as the electrode means, a so-called non-electrode type that is provided outside the container and causes inductive coupling type discharging or dielectric discharging can be used in addition to the pair of electrodes enclosed in the translucent airtight container.

[Ionization Medium]

An ionization medium is a characteristic constituent portion of this invention and contains a metal halide and rare gas.

(Metal Halide)

A metal halide contains at least one halide type of thulium (Tm) and holmium (Ho) of a preset ratio. The preset ratio is 30 mass % or more with respect to the entire amount of halides sealed in the translucent airtight container. Therefore, addition of other metal halides of up to 70 mass % at maximum is permitted. However, if the sealing ratio of at least one of thulium and holmium halides becomes less than 30 mass %, the lamp voltage is not raised to a desired range.

Further, if the sealing ratio of at least one type of halides of thulium and holmium becomes 50 mass % or more, it is preferable since a higher lamp voltage can be attained.

As a halogen configuring at least one type of halides of thulium and holmium, iodine is suitable since it has moderate reactivity, but either bromine or chlorine may be used as required, and two or more of iodine, bromine and chlorine can be used. Further, since the peak of light emission of thulium coincides with the peak of a visibility curve, thulium is an extremely effective luminous metal at enhancing the luminous efficiency. Further, holmium is similar to thulium in this property.

If the sealing ratio exceeds 80 mass %, the sealing ratio of halides of metals other than thulium and holmium is lowered accordingly and, as a result, desired white light emission cannot be attained, thus is not preferable to serve the purpose of attaining white light emission.

The other metal halides can be used for attaining white light emission as described above and added to at least one type of thulium and holmium and sealed. For example, this is to attain the purpose of adjusting the chromaticity of light emission or enhancing the luminous efficiency. The luminous efficiency becomes high when the sealing ratio is in the range of 50 to 70 mass %.

Since the other metal halides can be adequately added for various purposes, they are not specifically limited in this invention. Next, a main example of the other metal halides is explained.

1. (Alkali Metal)

If an alkali metal is provided with 60 mass % or less, preferably, 50 mass % or less with respect to the total amount of metal halides, the effect of a lowering in the lamp voltage can be attained. Further, approximately 30 mass % or less is optimum, but if various conditions of the luminous characteristic, manufacturing characteristic and the like are permitted, a lowering in the lamp voltage can be suppressed to minimum by sealing within an alkali metal in the range less than 3 mass %. Further, the luminous efficiency and lamp service life can be improved and the light color can be adjusted, particularly, the color deviation can be improved. From this viewpoint, the sealing process is permitted within a range in which a desired lamp voltage can be securely attained. It is preferably set to 2 to 8 mass %, more preferably 3 to 7 mass % and even more preferably 4 to 6 mass %. Further, as another alkali metal, one type or plural types of a group of sodium (Na), cesium (Cs) and lithium (Li) can be selectively sealed.

2. (Other Halides of Rare Earth Metals)

As a halide of a rare earth metal other than thulium and holmium, a halide of one type or plural types of rare earth metals of praseodymium (Pr), cerium (Ce) and samarium (Sm) can be sealed as a secondary component. The above rare earth metal is useful as a luminous metal next to a thulium halide and holmium halide and is permitted to be sealed at a certain sealing ratio or less. That is, since any one of the above rare earth metals has an enormous number of emission-line spectra near the peak wavelength of a visibility characteristic curve, this can contribute to enhancement of the luminous efficiency.

3. (Halide of Thallium (Tl) and/or Indium (In))

A halide of thallium (Tl) and/or indium (In) is permitted to be selectively sealed as a secondary component for the purpose of attaining desired color rendering properties and/or color temperatures or the like.

(Rare Gas)

Xenon (Xe) as a rare gas is sealed at 3 atm or higher at room temperature (25° C.). The reason why the sealing pressure of xenon is set high as described above is that the lamp voltage can be raised and the luminous efficiency can be enhanced. That is, in this invention, the rise of the lamp voltage by sealing at least one type of thulium and holmium with the above mixture ratio and the rise of the lamp voltage enabled by the sealing pressure of xenon can be both attained. As a result, a desired high lamp voltage can be attained. However, if the sealing pressure of xenon becomes lower than 3 atm, the lamp voltage rise cannot be attained to a desired degree. Therefore, if the sealing pressure of xenon becomes equal to or higher than 5 atm, it becomes suitable since the effect of the lamp voltage rise becomes significant. However, if it exceeds 15 atm, the rate of the lamp voltage rise becomes extremely dull.

On the other hand, the sealing pressure of xenon and the luminous efficiency indicate a positive correlation, but the expected luminous efficiency cannot be attained if it becomes lower than 3 atm. Further, if it exceeds 15 atm, the rise of the luminous efficiency becomes dull.

In view of the above facts, it is preferable to set the sealing pressure of xenon to 15 atm or lower.

[Metal or Metal Halide for Formation of Lamp Voltage]

In this invention, the mercury and metal halide for formation of lamp voltage are not substantially contained in the internal portion of the translucent airtight container. In the prior art, there are many cases in which a metal halide having an ionization energy of 8 eV or more and a melting point of 500° C. or lower is contained in a metal halide for formation of lamp voltage represented by ZnI₂ as a medium for formation of lamp voltage as described before. As the metal halide having an ionization energy of 8 eV or more and a melting point of 500° C. or lower, for example, halides of zinc (Zn), aluminum (Al) and manganese (Mn) are provided.

In the case of this invention, a desired lamp voltage is formed by sealing at least one type of thulium halide and holmium halide at a preset ratio and sealing xenon at 3 atm or higher. Therefore, the halide or mercury is not substantially sealed. In this case, the phrase not substantially sealed means that an impurity of 1 mass % or less of the total amount of the sealed material is contained is permitted.

The metal halide for formation of lamp voltage is high in vapor pressure in comparison with a halide sealed in the translucent airtight container in this invention and has a function of mainly determining the lamp voltage in the high-pressure discharge lamp. In this case, high in vapor pressure means that the vapor pressure during lighting is high, but it is not necessary to set an excessively high pressure as in the case of mercury and, preferably, the pressure in the airtight container during lighting is set to approximately 5 atm or lower. Therefore, if the above condition is provided, the halide is not limited to a particular metal halide.

Further, the halide for formation of the lamp voltage is mainly configured by a metal halide for formation of lamp voltage. For example, one type of plural types of metal halides selected from a group of magnesium (Mg), iron (Fe), cobalt (Co), chrome (Cr), zinc (Zn), nickel (Ni), manganese (Mn), aluminum (Al), antimony (Sb), beryllium (Be), rhenium (Re), gallium (Ga), titanium (Ti), zirconium (Zr) and hafnium (Hf) can be mainly used. The vapor pressure of most of them is lower than that of mercury and the adjustment range of the lamp voltage is narrower than that of mercury. However, the adjustment range of the lamp voltage can be enlarged by mixing and sealing plural types of metal halides, as required. For example, the lamp voltage is kept unchanged if AlI₃ is added when AlI₃ is set in an incomplete combustion state, thus the desired lamp voltage is not attained.

On the other hand, if ZnI₂ is added instead of AlI₃, the lamp voltage of an amount caused by the action of ZnI₂ is added. Therefore, the lamp voltage can be increased. Further, if another halide for formation of lamp voltage is added, a higher lamp voltage can be attained.

Further, the halide for formation of lamp voltage is a halide of a metal that is difficult to emit light in a visible region in comparison with the metal of the halide sealed in the translucent airtight container. The “difficult to emit light in the visible region in comparison with the metal of the halide” does not mean that visible light emission is less in the absolute meaning, but in the relative meaning. This is because ultraviolet region emission is certainly greater than visible region emission in the case of Fe and Ni, but light emission in the visible region is greater in the case of Ti, Al, Zn and the like. Therefore, if the metal with which visible region emission is greater is independently caused to emit light, energy is concentrated in the metal, and therefore, visible region emission becomes greater.

Ultraviolet region emission of Fe and Ni among the halides for formation of lamp voltage is large, but light emission of Ti, Al, Zn and the like is large in the visible light region if it is independently used for light emission. However, the energy level required for light emission of the halides of Ti, Al and Zn for formation of lamp voltage is higher than the energy level required for light emission of a halide (light emitting halide) as well as Tm that mainly contributes to light emission. Therefore, when both of them are simultaneously sealed and the lamp is lit, light emission in the visible region by the light emitting halide whose energy level is low becomes relatively dominant and light emission by the halide for formation of lamp voltage becomes less.

Therefore, the latter halide does not inhibit visible light emission, and the rate with respect to the total visible light radiated from the discharge lamp is low and the influence is less. However, it is made clear by experiments by the inventor and others that the high-pressure discharge lamp having both of the halides in a mixed state is inconvenient in the lamp characteristics, as will be described later.

[High-Voltage Pulse Generator]

A high-voltage pulse generator is means for generating a high-voltage pulse at the start time of a high-pressure discharge lamp and applying the same between the electrodes of the high-pressure discharge lamp to start the high-pressure discharge lamp. When the high-pressure discharge lamp is of a mercury-free type, a high-voltage pulse whose peak value is much higher than a high-voltage pulse applied to a mercury-containing high-pressure discharge lamp is required.

However, in this invention, the concrete configuration of the high-pressure generator is not particularly limited. A high-voltage pulse generator that generates a high-voltage pulse of a desired peak value can be configured by appropriate use of a known circuit and mounting structure.

[Current Introducing System]

A current conducting system is a conductor means for electrically connecting the high-pressure discharge lamp to the high-voltage pulse generator. The current conducting system is configured to have a dielectric strength of 9 kV or more, preferably, 25 kV or more so as not to cause dielectric deterioration or dielectric breakdown due to the high-voltage pulse generated from the high-voltage pulse generator. Means for enhancing the dielectric strength as described above is not particularly limited in this invention, and any known means for enhancing the dielectric strength can be appropriately used.

Further, the concrete configuration of the current conducting system is not particularly limited in this invention. For example, when a base is provided on the high-pressure discharge lamp side to electrically connect and mechanically support the high-pressure discharge lamp, the base configures part of the current conducting system. In addition, a lamp socket is used as means for electrically connecting the high-voltage pulse generator and lighting circuit to the high-pressure discharge lamp and mechanically supporting the high-pressure discharge lamp in some cases. In this case, the lamp socket also configures part of the current conducting system. Naturally, the current conducting system also comprises conductive wires, for example, conductive bodies such as cables, connectors and terminals lying between the high-voltage pulse generator and the high-pressure discharge lamp.

[Configuration of Other Parts]

In this invention, the following configurations can be selectively added as required.

1. (Outer Tube)

The constituent part having the translucent airtight container, a pair of electrodes and discharge medium is used as a luminous tube and the luminous tube can be arranged in the internal portion of the outer tube. The outer tube can be formed of a given desired shape and size. Further, the internal portion of the outer tube can be made airtight with respect to the exterior and kept in a vacuum or low-pressure state, the temperature of the coolest portion of the luminous tube may be raised or it may be communicated with atmospheric air when the material of the luminous tube is quartz. When it is made airtight with respect to atmospheric air, an inert gas such as argon, nitrogen or the like can be sealed as required. Further, the outer tube can be formed by use of a translucent material such as quartz glass, hard glass, soft glass or the like.

2. (Reflection Mirror)

The translucent airtight container can be fixedly arranged in a preset position in the reflection mirror. In this case, as the reflection mirror, a member having an infrared transmission/visible light reflection type dichroic mirror formed on the internal surface of a glass base body can be used.

3. (Rated Lamp Power)

In this invention, the rated lamp power of the high-pressure discharge lamp can be freely set in a wide range of values and can be set to a given value of several kW or less, for example. Various values are permitted according to intended function; vehicle headlights, projection, general illumination or the like, for example. Therefore, an airtight container of an adequate shape and size, the electrode-electrode distance of an adequate value and a sealing amount of a discharging medium of an adequate value can be set according to the rated lamp power and intended function.

[Operation of High-Pressure Discharge Lamp in Present Invention]

The operation of the high-pressure discharge lamp of this invention is as follows.

1. A practical high lamp voltage can be attained. In this invention, the lamp voltage can be set high when at least one type of thulium and holmium in an ionization medium is sealed with a preset sealing rate. Further, the lamp voltage is set high by sealing xenon at a preset pressure. Thus, in this invention, a desired lamp voltage can be attained by both of the lamp voltage raising operations.

Therefore, in this invention, required and practical lamp voltage can be attained without sealing mercury and a halide for formation of lamp voltage that is formed of a halide of a metal such as ZnI₂ having ionization energy of 8 eV or more and a melting point of 500° C. or lower as in the prior art.

2. A practical luminous characteristic can be attained. In this invention, light emission of white light series is emitted with high efficiency by sealing at least one type of halides of thulium and holmium with a preset sealing ratio. Therefore, in this invention, a required and practical luminous efficiency can be attained.

3. The color deviation is reduced. In this invention, at least one type of halides of thulium and holmium is sealed with a preset sealing ratio and, for example, ZnI₂ is not sealed as a halide for formation of lamp voltage. Thus, x in a chromaticity diagram tends to increase and y tends to decrease. As a result, the plus color deviation value becomes smaller and the chromaticity is improved in a direction closer to a black body radiation line. On the other hand, for example, if ZnI₂ is not sealed in an ScI₃—NaI series, which is a known sealing material, there occurs a problem that both of x and y in the chromaticity diagram increase and the plus color deviation value is further enlarged.

4. The lamp service life is improved. (1) In this invention, since a halide for formation of lamp voltage having high moisture absorbency is not sealed, water as an impurity is not brought into the internal portion of the translucent airtight container. As a result, the lamp service life is improved. (2) Since a halide for formation of lamp voltage is not sealed, cloudiness caused by a reaction between the halide and the translucent airtight container does not occur. As a result, the lamp service life is improved.

5. A rise in the manufacturing cost can be prevented. In this invention, since a halide for formation of lamp voltage is not sealed, the problem described above in a pellet manufacturing process does not occur. Therefore, a rise in the manufacturing cost can be prevented.

The lighting apparatus of this invention is characterized by including a lighting apparatus main body, a high-pressure discharge lamp of this invention arranged in the lighting apparatus main body and a lighting device that lights the high-pressure discharge lamp.

In this invention, the concept of a lighting apparatus embraces a device having the high-pressure discharge lamp of this invention as a light source, and a lighting fitting, beacon light, pilot lamp or photochemical reaction device, for example. The term lighting apparatus main body refers to the parts of the lighting apparatus other than the high-pressure discharge lamp.

[Other Aspects in the Present Invention]

As other aspects of the high-pressure discharge lamp of this invention, aspects of part or all of first to eleventh aspects described below can be used.

(First Aspect)

In the first aspect, the distance between the high-pressure discharge lamp and the high-voltage pulse generator is 60 to 500 mm when the rated lamp power of the high-pressure discharge lamp is 50 to 150 W, 80 to 500 mm when the rated lamp power is 150 to 400 W and 130 to 500 mm when the rated lamp power is 400 to 1000 W. In this case, it is supposed that the above distance indicates the linearly spatial distance between the central position of the luminous tube of the high-pressure discharge lamp and the center-of-mass position of the high-voltage pulse generator. If the above distance becomes shorter than the lower limits in the respective rated lamp powers, the high-voltage pulse generator is influenced by a high operation temperature at the lighting time of the high-pressure discharge lamp and tends to break down since the temperature rise thereof becomes significant.

On the other hand, if the above distance exceeds the upper limit of 500 mm irrespective of the rated lamp power, an attenuation amount of the high-voltage pulse becomes excessively large even if a sufficient peak value and pulse power are obtained in the high-voltage pulse generator. As a result, the peak value and pulse power of the high-voltage pulse applied to the high-pressure discharge lamp will become lower than values required for stably starting the high-pressure discharge lamp. If the upper limit of the above distance is within 300 mm, attenuation in the high-voltage pulse becomes less in practice and a high-voltage pulse with a sufficient peak value and pulse power can be applied. If the upper limit of the above distance is set to 150 to 200 mm according to the rated lamp power, attenuation in the high-voltage pulse becomes further reduced, which is optimum.

(Second Aspect)

In the second aspect, the high-pressure discharge lamp is used in a lighting attitude other than horizontal, such as in oblique or vertical lighting. Such lighting attitudes are applied to a general illumination service.

(Third Aspect)

In the third aspect, the rated lamp power of the high-pressure discharge lamp is set to 50 W or more, preferably, 70 W or more. Such rated lamp power is applied to a general illumination service.

(Fourth Aspect)

In the fourth aspect, the high-voltage pulse generator and a lighting main circuit (ballast) are separated by 2 m or more. This distance refers to the length of a conductive wire, for example, a cable that connects the high-voltage pulse generator to the lighting main circuit. Such distance is preferably set to 10 m or more. For a high-pressure discharge lamp, the high-voltage pulse generator is arranged relatively close to the high-pressure discharge lamp, but since the lighting main circuit is arranged at a relatively long distance from the high-pressure discharge lamp in some cases, the high-pressure discharge lamp of this invention is configured to be correctly operated in the above arrangement example.

(Fifth Aspect)

In the fifth aspect, the high-voltage pulse generator and high-pressure discharge lamp are mechanically integrated. In this aspect, the high-pressure discharge lamp and high-voltage pulse generator are inseparably integrated without using a base and lamp socket. In this aspect, the high-pressure discharge lamp and high-voltage pulse generator are removably mounted on a lighting apparatus in an integrated state.

(Sixth Aspect)

In the sixth aspect, the high-pressure discharge lamp has a base and the high-voltage pulse generator has a lamp socket. In this aspect, the high-pressure discharge lamp and high-voltage pulse generator are detachably provided between the base and the lamp socket. In this aspect, the high-pressure discharge lamp can be removably mounted on a lighting apparatus in a state in which it is separated from the high-voltage pulse generator.

(Seventh Aspect)

In the seventh aspect, the high-pressure discharge lamp and high-voltage pulse generator are connected via a conductive wire contained in the current conducting system. Thus, the high-pressure discharge lamp is configured to be separable from the high-voltage pulse generator at a portion of the conductive wire. In this configuration, a connector may be inserted into a separating portion of the conductive wire to permit separation at the connector.

(Eighth Aspect)

In the eighth aspect, a configuration is adopted in which a high-voltage pulse generator and a lighting main circuit are connected via a second conductive wire to permit the high-voltage pulse generator to be separable from the lighting main circuit at the portion of the second conductive wire in the seventh aspect. In this configuration, a connector can be inserted into a separating portion of the second conductive wire to permit separation at the connector.

(Ninth Aspect)

In the ninth aspect, a configuration is adopted to hold the maximum temperature of the internal portion of the high-voltage pulse generator during lighting of the high-pressure discharge lamp at 170° C. or lower, preferably, 120° C. or lower. For this purpose, known heat radiation means and heat insulation means can be appropriately applied to the high-voltage pulse generator.

(Tenth Aspect)

The tenth aspect includes a lighting main circuit (ballast), configured as desired, in addition to the high-pressure discharge lamp of this invention. The lighting main circuit may be formed with a desired configuration. Further, a lighting system of an alternating current lighting system or direct current lighting system can be used. In the case of alternating current lighting, for example, an electronic lighting circuit mainly having inverters can be configured. A DC-DC conversion circuit such as a step-up chopper or step-down chopper can be added to a DC power source connected between input terminals of inverters as required. In the case of direct current lighting, for example, an electronic lighting circuit mainly having the above DC-DC conversion circuit can be configured.

(Eleventh Aspect)

The eleventh aspect is a lighting apparatus having the high-pressure discharge lamp of this invention. The lighting apparatus is characterized by including a lighting apparatus main body, the high-pressure discharge lamp of this invention arranged on the lighting apparatus main body and a lighting main circuit that lights the high-pressure discharge lamp in the high-pressure discharge lamp apparatus.

In this aspect, the concept of a lighting apparatus embraces all types of devices that use a high-pressure discharge lamp as a light source. For example, various types of illumination fittings for outdoors and indoors, car headlights, image or video projection devices, beacon lights, signal lights, pilot lamps, chemical reaction devices, checking devices and the like may be provided.

The term lighting apparatus main body refers to the parts of the lighting apparatus other than the high-pressure discharge lamp and lighting main circuit.

The lighting main circuit may be arranged apart from the lighting apparatus main body.

### EFFECT OF PRESENT INVENTION

According to this invention, it is possible to provide a high-pressure discharge lamp that has practical electrical characteristics and luminous characteristics without substantially sealing mercury and mercury-substitute material, that is, a halide for formation of lamp voltage and is free from problems in a pellet manufacturing process and in which the color deviation is low and the service life characteristic is improved, and also provide a lighting apparatus having the same.

According to this invention, it is possible to provided a practical high-pressure discharge lamp apparatus that can be easily started and has starting ability with high reliability over a long period of time by connecting a mercury-free high-pressure discharge lamp to a high-voltage pulse generator by use of a current conducting system having a dielectric strength of 9 kV or more.

Further, according to this invention, it is possible to provide a practical high-pressure discharge lamp apparatus in which attenuation of a high-voltage pulse is reduced, reliability of a high-voltage pulse generator is high, and that it is highly adaptable to various types of illumination fittings and is easy to handle, in addition to the above-described facts.

### BRIEF DESCRIPTION OF THE SEVERAL VIEWS OF THE DRAWING

FIG. 1 is a cross-sectional view showing a first aspect for embodying a high-pressure discharge lamp of this invention.

FIG. 2 is a graph showing the relation between the sealing ratio of a thulium halide, lamp voltage and luminous efficiency.

FIG. 3 is a graph showing the relation between the sealing pressure of xenon, lamp voltage and luminous efficiency.

FIG. 4 is a front view showing a second aspect for embodying the high-pressure discharge lamp of this invention.

FIG. 5 is a cross-sectional view showing a ceiling-recessed downlight as one aspect for embodying a lighting apparatus of this invention.

FIG. 6 is a front view of the whole portion of a high-pressure discharge lamp apparatus showing the first aspect for embodying the high-pressure discharge lamp apparatus of this invention.

FIG. 7 is an exploded front view of FIG. 6.

FIG. 8 is a graph showing the results of experiments performed for variations of the operation temperature of a high-voltage pulse generator and attenuation of a high-voltage pulse when the distance between the high-pressure discharge lamp and the high-voltage pulse generator is varied in an embodiment of this invention.

FIG. 9 is an exploded front view showing a second aspect for embodying this invention.

FIG. 10 is an exploded front view showing a third aspect for embodying this invention.

FIG. 11 is a block circuit diagram showing a fourth aspect for embodying this invention.

### DETAILED DESCRIPTION OF THE INVENTION

There will now be described aspects for embodying this invention with reference to the drawings.

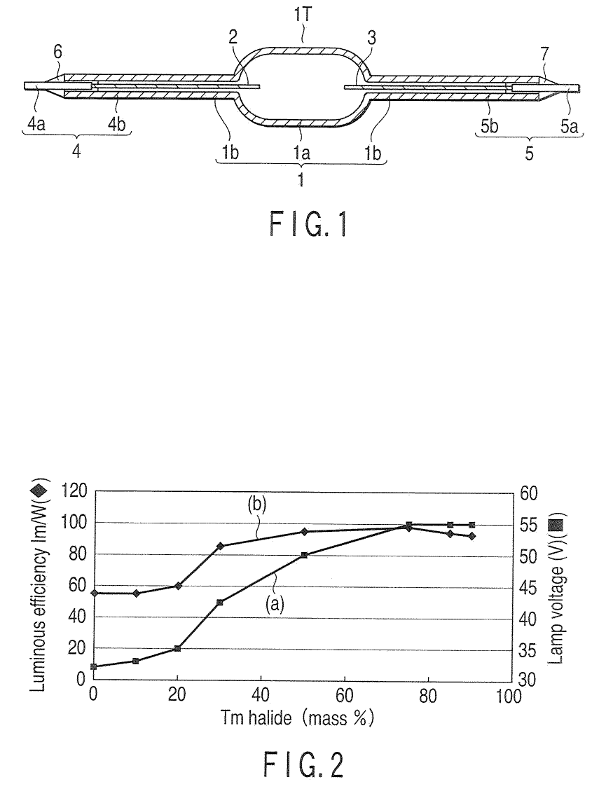

FIG. 1 is a cross-sectional view showing a first aspect for embodying a high-pressure discharge lamp of this invention. The high-pressure discharge lamp of this aspect is a metal halide lamp that can be adapted to various services for general illumination, car headlights and the like. The high-pressure discharge lamp includes a translucent airtight container 1, a pair of electrodes 2, 3, a pair of current conducting conductors 4, 5, a pair of sealing members 6, 7, and an ionization medium. The above constituents are assembled and integrated as required to configure a luminous tube IT and enclosed in an outer tube (not shown) for use.

The translucent airtight container 1 is formed of a translucent ceramic, for example, translucent polycrystalline alumina ceramic. The translucent airtight container 1 has a surrounding portion 1a and a pair of small-diameter cylindrical portions 1b, 1b integrated with the surrounding portion 1a, formed as an integrated structure. The surrounding portion 1a is formed into a straw-bag shape and is formed of an intermediate cylindrical portion and a pair of hemispherical portions continuous to both ends thereof. The small-diameter cylindrical portion 1b is formed into a long and narrow pipe shape and the end thereof is communicated with the central portion of the hemispherical portion of the surrounding portion 1a.

The electrodes 2, 3 are formed of rod-like bodies of doped tungsten. One end of the electrode 2 faces the internal portion of the surrounding portion 1a of the translucent airtight container 1 and the other end thereof is butt-welded to the end of the current conducting conductor 4. The intermediate portion of the electrode 2 is inserted into the internal portion of the small-diameter cylindrical portion 1b while forming a capillary, which is a small gap, on the periphery thereof. One end of the electrode 3 faces the internal portion of the surrounding portion 1a of the translucent airtight container 1 and the other end thereof is butt-welded to the end of the current conducting conductor 5. The intermediate portion of the electrode 3 is inserted into the internal portion of the small-diameter cylindrical portion 1b while forming a capillary, which is a small gap, on the periphery thereof.

The current conducting conductor 4 has a sealing/depositing portion 4a and halogen-resistant portion 4b that are serially connected. The current conducting conductor 5 has a sealing/depositing portion 5a and halogen-resistant portion 5b that are serially connected. The sealing/depositing portion 4a is formed of a rod-like body of niobium and cooperated with the sealing member 6 to seal the translucent airtight container 1 and the base end thereof is exposed to the exterior of the translucent airtight container 1. The sealing/depositing portion 5a is formed of a rod-like body of niobium and cooperated with the sealing member 7 to seal the translucent airtight container 1 and the base end thereof is exposed to the exterior of the translucent airtight container 1. The halogen-resistant portion 4b is formed of a rod-like body of molybdenum and the base end thereof is butt-welded to the end of the sealing/depositing portion 4a and inserted into the internal portion of the small-diameter cylindrical portion 1b of the translucent airtight container 1. Further, the end portion thereof is welded to the base end of the electrode 2. The halogen-resistant portion 5b is formed of a rod-like body of molybdenum and the base end thereof is butt-welded to the end of the sealing/depositing portion 5a and inserted into the internal portion of the small-diameter cylindrical portion 1b of the translucent airtight container 1. Further, the end portion thereof is welded to the base end of the electrode 3.

The sealing members 6, 7 are formed of flit glass, that is, molten solidified bodies of ceramic compounds. The sealing member 6 is inserted into the small-diameter cylindrical portion 1b and filled into a gap between the sealing/depositing portion 4a of the current conducting conductor 4 lying in the small-diameter cylindrical portion 1b and the internal surface of the small-diameter cylindrical portion 1b and surrounds the surface of the sealing/depositing portion 4a so as not to be exposed to the internal portion of the translucent airtight container 1. The sealing member 7 is inserted into the small-diameter cylindrical portion 1b and filled into a gap between the sealing/depositing portion 5a of the current conducting conductor 5 lying in the small-diameter cylindrical portion 1b and the internal surface of the small-diameter cylindrical portion 1b and surrounds the surface of the sealing/depositing portion 5a so as not to be exposed to the internal portion of the translucent airtight container 1.

The ionization medium is formed of a metal halide and rare gas. The metal halide contains at least one type of halides of thulium and holmium with the ratio of 30 mass % or more with respect to the entire amount of halide. Further, a metal halide or metal having an ionization energy of 8 eV or more and a melting point of 500° C. or lower is not contained. The rare gas is formed of xenon of 3 atm at room temperature (25° C.).

### Embodiment 1

The embodiment 1 is a halide lamp shown in FIG. 1.

Translucent airtight container: Integral formation, length of surrounding portion 8 mm, maximum inner diameter 2.9 mm, thickness 0.5 mm, entire length 34 mm,

Pair of electrodes: Electrode-electrode distance 4.2 mm,

Ionization medium: TmI₃—NaI (75:25 mass %)=2 mg, Xe 13 atm,

Electrical characteristic: Lamp voltage 55 V, lamp power 30 W,

Luminous characteristic: Luminous efficiency 97 μm/W,

Color deviation duv.: 0.0030.

### Embodiment 2

Ionization medium: HoI₃—NaI (75:25 mass %)=2 mg, Xe 13 atm,

The other items are the same as those of embodiment 1.

Electrical characteristic: Lamp voltage 52 V, lamp power 30 W,

Luminous characteristic: Luminous efficiency 94 μm/W,

Color deviation duv.: 0.0020.

### Comparison Example 1

Ionization medium: TmI₃—NaI (75:25 mass %)=1 mg, ZnI₂=1 mg, Xe 13 atm,

The other items are the same as those of embodiment 1.

Electrical characteristic: Lamp voltage 70 V, lamp power 30 W,

Luminous characteristic: Luminous efficiency 100 μm/W,

Color deviation duv.: 0.0070.

### Embodiment 3

Ionization medium: TmI₃—NaI (75:25 mass %)=2 mg, Xe 5 atm,

The other items are the same as those of embodiment 1.

Electrical characteristic: Lamp voltage 40 V, lamp power 30 W,

Luminous characteristic: Luminous efficiency 87 μm/W,

Color deviation duv.: 0.0050.

### Embodiment 4

Ionization medium: TmI₃—NaI—TlI (40:40:20 mass %)=2 mg, Xe 13 atm,

Electrical characteristic: Lamp voltage 45 V, lamp power 30 W,

Luminous characteristic: Luminous efficiency 97 μm/W,

Color deviation duv.: 0.0080.

The embodiments 1 and 2 are common in that they do not contain ZnI₂ in the ionization medium in comparison with comparison example 1. However, the lamp voltage is set within a sufficiently practicable range although it is not comparable with comparison example 1. Further, the luminous efficiency can be said to be substantially equal to comparison example 1. In addition, the color deviation is extremely preferable in comparison with the comparison example and the color deviation is extremely small particularly in embodiment 2, in which a holmium halide is sealed.

When embodiment 3 is compared with embodiment 1, the sealing pressure of xenon is lowered to 5 atm and both of the lamp voltage and luminous efficiency are lower than those of embodiment 1, but they are set within a sufficiently practicable range. Further, the color deviation is obviously small in comparison with comparison example 1 although it is larger than that of embodiment 1.

When embodiment 4 is compared with embodiment 1, it differs in that TlI is added to the halide and the lamp voltage and luminous efficiency are set within a sufficiently practicable range, although both of them are slightly lower. However, the color deviation is slightly deteriorated in comparison with comparison example 1.

FIG. 2 is a graph showing the relation between the sealing ratio of a thulium halide, lamp voltage and luminous efficiency. In FIG. 2, the abscissa indicates the sealing ratio (mass %) of the thulium halide to the entire amount of halide and the ordinate indicates the lamp voltage (V) on the right side and the luminous efficiency lm/W on the left side. Further, a line (a) in FIG. 2 indicates the lamp voltage and a line (b) indicates the luminous efficiency.

As is understandable from FIG. 2, a practical lamp voltage can be attained as the lamp voltage if the sealing ratio of the thulium halide is set to 30% or more. On the other hand, if it is less than 30%, the lamp voltage is too low to be practical.

Further, a high and practical luminous efficiency can be attained as the luminous efficiency if the sealing ratio of the thulium halide is set to 30% or more. On the other hand, if the sealing ratio becomes less than 30%, the luminous efficiency is rapidly lowered and becomes impractical.

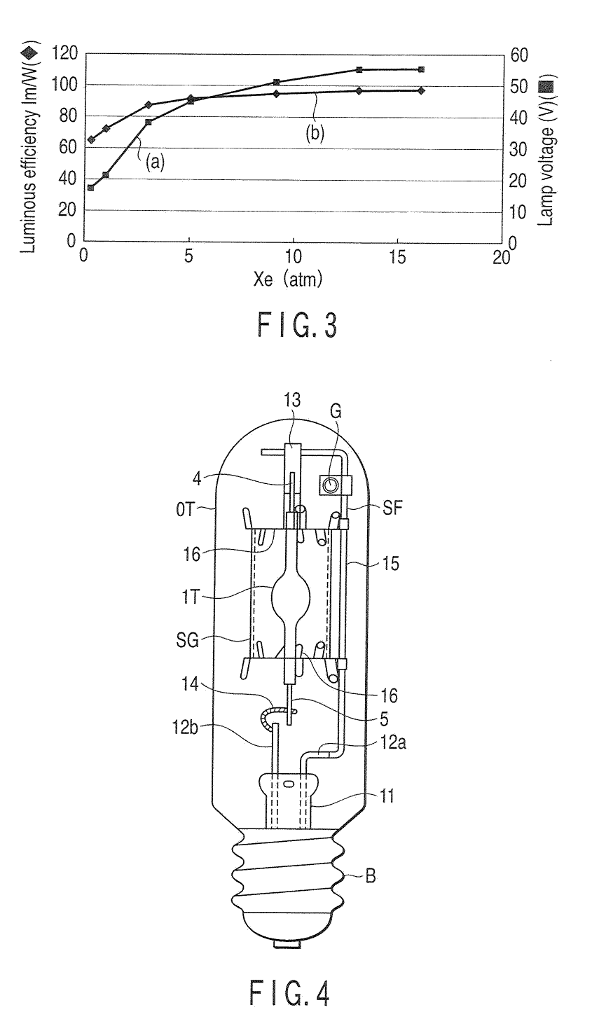

FIG. 3 is a graph showing the relation between the sealing pressure of xenon, lamp voltage and luminous efficiency. In FIG. 3, the abscissa indicates the sealing pressure (atm) of xenon and the ordinate indicates the lamp voltage (V) on the right side and the luminous efficiency lm/W on the left side. Further, a line (a) in the drawing indicates the lamp voltage and a line (b) indicates the luminous efficiency.

As is understandable from FIG. 3, a practical lamp voltage can be attained as the lamp voltage if the sealing pressure of xenon is set to 3 atm or higher. On the other hand, if it is lower than 3 atm, the lamp voltage is rapidly lowered and a practical lamp voltage cannot be attained.

Further, the luminous efficiency becomes high and a practical luminous efficiency can be attained as the luminous efficiency if the sealing pressure of xenon is set to 3 atm or higher. On the other hand, if the sealing ratio becomes lower than 3 atm, the luminous efficiency is rapidly lowered and becomes impractical since a desired lamp voltage cannot be attained.

FIG. 4 is a front view showing a second aspect for embodying the high-pressure discharge lamp of this invention. In FIG. 4, the same symbols are attached to portions that are the same as those of FIG. 1 and the explanation thereof is omitted. This aspect is a metal halide lamp with a rated lamp power of 100 W and with a luminous tube IT contained in an outer tube OT. Further, in the drawing, SG is shroud glass, SF is a luminous tube supporting member, G is a getter and B is a base.

As the outer tube OT, a T-type bulb formed of hard glass is used. Then, members such as the luminous tube IT, shroud glass SG and luminous tube supporting member SF are attached at preset positions in the internal portion. Further, the outer tube OT has a flare stem 11 sealed/enclosed on a neck portion that is positioned in the lower portion in FIG. 4. The flare stem 11 has a pair of internal lead-in wires 12a, 12b protruding into the outer tube OT in an airtight fashion.

The luminous tube IT has the same configuration as that shown in FIG. 1. A current conducting conductor 4 in the upper portion is welded to and supported by a connecting portion 13 as will be described later and connected to the internal lead-in wire 12a via the luminous tube supporting member SF. Further, in the luminous tube IT, a current conducting conductor 5 in the lower portion is welded to and supported by a connection conductor 14 and connected to the internal lead-in wire 12b via the connection conductor 14.

The shroud glass SG is formed of a cylindrical body of quartz glass, surrounds the luminous tube IT with a gap with respect to the periphery thereof and is supported by the luminous tube supporting member SF

The luminous tube supporting member SF is configured by a supporting frame 15, a pair of supporting plates 16, 16 and connecting portion 13. The supporting frame 15 is formed by bending a stainless steel rod into the form of a longitudinally deformed “c” and is connected to the internal lead-in wire 12a. The pair of supporting plates 16, 16 are formed by forming stainless steel plates into substantially a disc form and fixed on the supporting frame 15. Further, through holes are formed in the central portions of the pair of supporting plates 16, 16 and small-diameter cylindrical portions 2b, 2b of a translucent airtight container 2 are inserted into the through holes. As a result, they fix the luminous tube IT in the tube axial position of the outer tube OT and support the luminous tube IT in the tube axial direction thereof. The connecting portion 13 is welded to the upper portion of the supporting frame 15 and connected to the current conducting conductor 4 lying above the luminous tube IT in the drawing. The pair of supporting plates 16, 16 are engaged with the upper and lower end faces of the shroud glass SG, sandwich and hold the shroud glass SG therebetween and are fixed on the luminous tube supporting member SF. Therefore, the shroud glass SG is supported by the luminous tube supporting member SF via the pair of supporting plates 16, 16.

The getter G is a performance getter supported on the upper portion of the luminous tube supporting member SF. The base B is formed of an E26-type screw base and mounted on the neck portion of the outer tube OT. The base B is connected to the pair of internal lead-in wires 12a, 12b with the outer tube OT kept airtight.

### Embodiment 5

The embodiment 5 is the metal halide lamp shown in FIG. 4.

Translucent airtight container: Integral formation, length of surrounding portion 18 mm, maximum inner diameter 10 mm, thickness 0.7 mm, entire length 40 mm,

Pair of electrodes: Electrode-electrode distance 10 mm,

Ionization medium: TmI₃—NaI (75:25 mass %)=4 mg, Xe 13 atm,

Electrical characteristic: Lamp voltage 70 V, lamp power 100 W,

Luminous characteristic: Luminous efficiency 97 μm/W,

Color deviation duv.: 0.0030.

According to embodiment 5, the ionization medium is the same as that in embodiment 1, but the lamp voltage is 70 V.

FIG. 5 is a cross-sectional view showing a ceiling-recessed downlight as one aspect for embodying a lighting apparatus of this invention. In FIG. 5, a lighting apparatus 21 configured by the ceiling-recessed downlight is configured to include a high-pressure discharge lamp 22 and illumination fitting main body 23. The high-pressure discharge lamp 22 has the same configuration as that in the second aspect for embodying the high-pressure discharge lamp of this invention shown in FIG. 4.

The illumination fitting main body 23 is a ceiling-recessed downlight main body and includes a base body 24 and reflector plate 25. The base body 24 has a ceiling surface abutting edge 28 in the lower end so as to be recessed in the ceiling. The reflector plate 25 is supported by the base body 24 and surrounds the high-pressure discharge lamp 22 so that the luminous center thereof will be substantially set on a focus thereof.

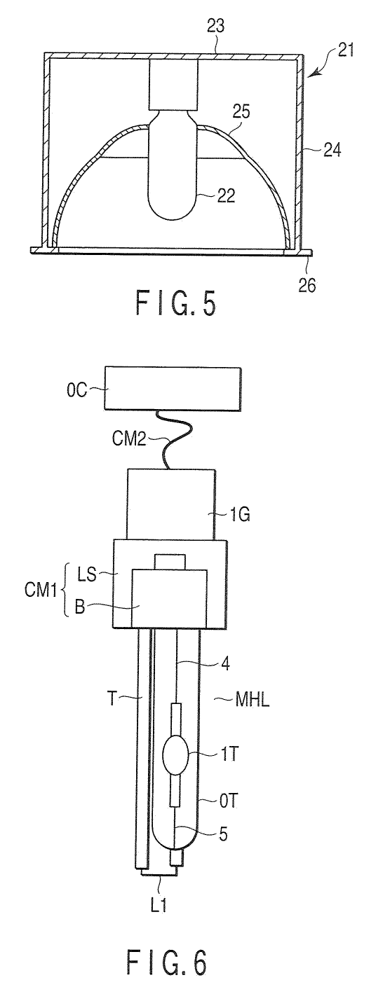

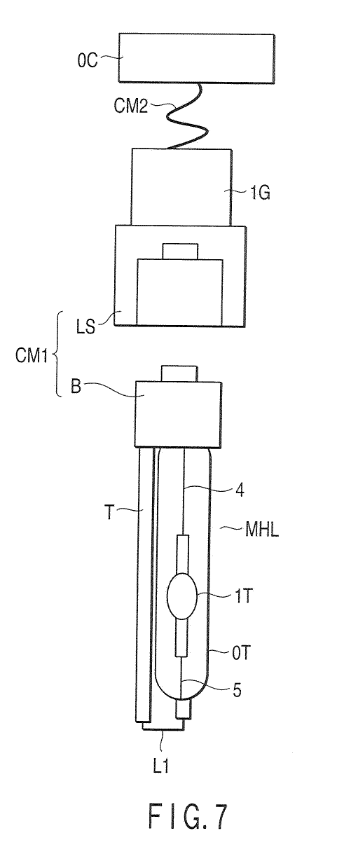

FIG. 6, FIG. 7 and FIG. 1 show a first aspect for embodying the high-pressure discharge lamp apparatus of this invention, FIG. 6 is a front view of the whole portion of the high-pressure discharge lamp apparatus and FIG. 7 is an exploded front view. Further, the enlarged cross-sectional view of a luminous tube that is one constituent of the high-pressure discharge lamp is as described with reference to FIG. 1. The high-pressure discharge lamp apparatus includes a high-pressure discharge lamp MHL, high-voltage pulse generator IG and current conducting system CM1. Further, the high-pressure discharge lamp MHL is started by application of a high-voltage pulse generated from the high-voltage pulse generator IG and sustains the lighting state by use of a lighting main circuit OC.

The high-pressure discharge lamp MHL is configured by using a luminous tube IT, lead wire L1, insulator tube T, outer tube OT and base B as main components.

The luminous tube IT is configured by a translucent airtight container 1, electrodes 2, 3, current conducting conductors 4, 5, sealing members 6, 7 and discharging medium as described before.

In FIG. 6, the end of the lead wire L1 penetrates through the lower portion of the outer tube OT as will be described later in FIG. 6 in an airtight fashion, is connected via welding to the base end of the current conducting conductor 5 lying below the luminous tube IT and supports the luminous tube IT in a preset position in the outer tube OT. The current conducting conductor 4 lying above the luminous tube IT in the drawing is supported by the other lead wire that is omitted in the drawing in the same manner as described above. Further, the other lead wire extends along the tube axis and is guided into the base B that will be described later and connected to one base terminal that is not shown in the drawing. On the other hand, the lead wire L1 is folded back at the intermediate portion along the outer tube OT as will be described later, guided into the base B and connected to the other base terminal arranged in the base B.

The insulator tube T is formed of a ceramic tube that covers the lead wire L1. The outer tube OT contains the luminous tube IT in the internal portion and the internal portion is airtight with respect to atmospheric air. The base B is mounted on one end portion of the outer tube OT.

The high-voltage pulse generator IG has a lamp socket LS integrated therewith. Then, the high-voltage pulse generator IG is electrically connected to the lamp socket LS so as to apply a high-voltage pulse output therefrom to the lamp socket LS although not shown in the drawing. Therefore, the high-pressure discharge lamp MHL is removably connected to the high-voltage pulse generator IG and lighting main circuit OC that will be described later by mounting the base B on the lamp socket LS. Further, FIG. 7 shows a state in which the high-pressure discharge lamp MHL is separated from the lamp socket LS.

The current conducting system CM1 is conducting means lying in a conduction path extending from the output terminal of the high-voltage pulse generator IG to the luminous tube IT and contains the lamp socket LS and the base B of the high-pressure discharge lamp MHI, in this aspect.

The lighting main circuit OC is circuit means for permitting the started high-pressure discharge lamp MHL to continuously and stably perform arc discharging. In this case, the lighting main circuit OC configures a high-pressure discharge lamp lighting device in cooperation with the high-pressure discharge lamp apparatus. Further, the lighting main circuit OC and high-pressure discharge lamp apparatus are electrically connected via a second current conducting system CM2, but they can be spatially separately arranged.

### Embodiment 6

Translucent ceramic airtight container: Made of an integrally formed translucent alumina ceramic, Surrounding portion; Length 18 mm, maximum outer diameter 13 mm, Small-diameter cylindrical portion; Outer diameter 2.7 mm, length 14 mm,

Ionization medium: TmI₃—NaI

(75:25 mass %)=10 mg, Xe 10 atm,

Rated lamp power: 150 W,

High-voltage pulse generator: High-voltage pulse 24 kV, operation temperature 90° C.,

Dielectric strength of current conducting system: 28 kV,

Distance between high-pressure discharge lamp and high-voltage pulse generator: 180 mm

### Comparison Example 2

Translucent airtight container: Made of quartz glass, Surrounding portion; Length 10 mm, maximum outer diameter 10 mm,

Ionization medium: ScI₃—NaI—ZnI₂: 0.4 mg, Xe 10 atm,

Rated lamp power: 70 W,

High-voltage pulse generator: High-voltage pulse 24 kV, operation temperature 90° C.,

Dielectric strength of current conducting system: 28 kV,

Distance between high-pressure discharge lamp and high-voltage pulse generator: 70 mm

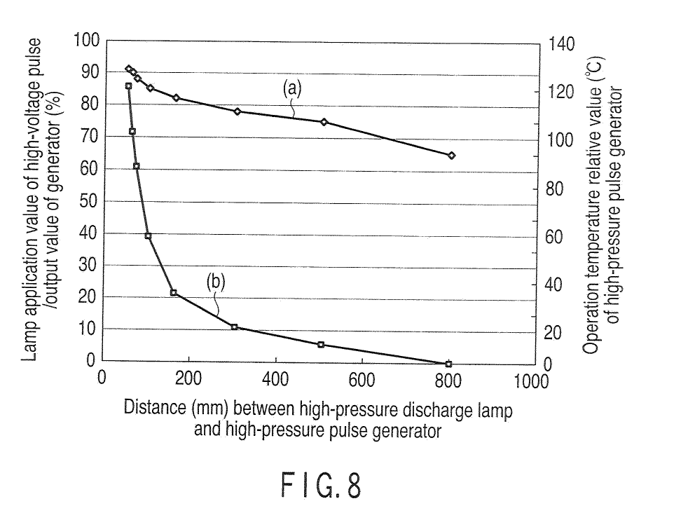

FIG. 8 is a graph showing the results of experiments performed for variations of the operation temperature of the high-voltage pulse generator and attenuation of a high-voltage pulse when the distance between the high-pressure discharge lamp and the high-voltage pulse generator is varied in an embodiment of this invention. In FIG. 8, the abscissa indicates the distance (mm) between the high-pressure discharge lamp and the high-voltage pulse generator and the ordinate indicates the lamp application value of the high-voltage pulse/output value of the generator on the left side and the operation temperature relative value (° C.) of the high-voltage pulse generator on the right side. In this case, the high-voltage pulse used for the experiments is 25 kV, 2 MHz. Further, the operation temperature of the high-voltage pulse generator is an operation temperature at the center-of-mass position. A curve (a) in the drawing indicates the degree of attenuation of the high-voltage pulse and a curve (b) indicates the operation temperature of the high-voltage pulse generator.

As is understandable from FIG. 8, it is clear that the high-pressure discharge lamp MHL can be stably started according to the curve (a) if the distance between the high-pressure discharge lamp MHL and the high-voltage pulse generator IG is set to 500 mm or shorter. This is because 19 kV or higher, which is approximately 75% of the initial value, can be applied even if the high-voltage pulse is attenuated. Further, according to the curve (b), the temperature rise of the high-voltage pulse generator IG becomes excessively large if the distance between the high-pressure discharge lamp and the high-voltage pulse generator becomes shorter than 60 mm. Therefore, in a case of the high-pressure discharge lamp MHL with the rated lamp power of 150 W used for the experiments, it is understood that the distance between the high-pressure discharge lamp MHL and the high-voltage pulse generator IG is adequate if set in the range of 60 to 500 mm.

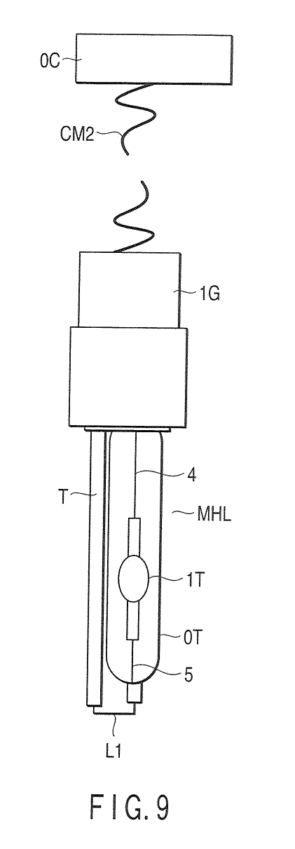

Next, the other aspects for embodying this invention are explained with reference to FIGS. 9 to 11. In this case, the same symbols are attached to portions that are the same as those of FIG. 6 and the explanation thereof is omitted.

FIG. 9 is an exploded front view showing a second aspect for embodying this invention. In this aspect, a second current conducting system CM2 that connects a high-voltage pulse generator IG and a lighting main circuit OC to each other is separately provided. Although not shown in the drawing, the configuration is made such that separation of the second current conducting system CM2 can be performed in a portion of a connector inserted. Further, the connector can be arranged in the intermediate portion of a conducting wire, a connecting portion between the conducting wire and the high-voltage pulse generator IG or a connecting portion between the conducting wire and the lighting main circuit OC.

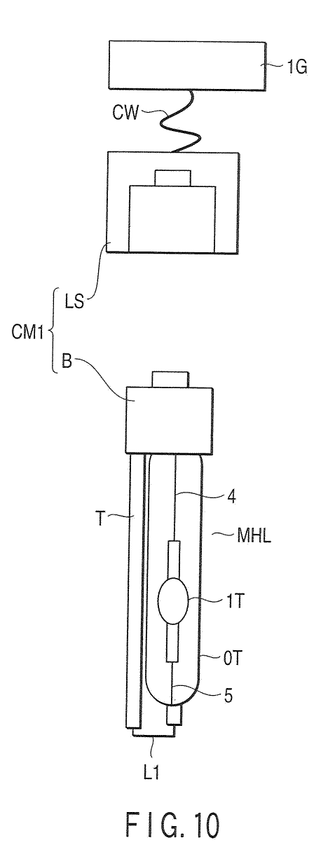

FIG. 10 is an exploded front view showing a third aspect for embodying this invention. In this aspect, a lamp socket LS and a high-voltage pulse generator IG are separated and they are connected via a conductive wire CW. Therefore, in this aspect, a base B, lamp socket LS and conductive wire CW are contained in a current conducting system CM1.

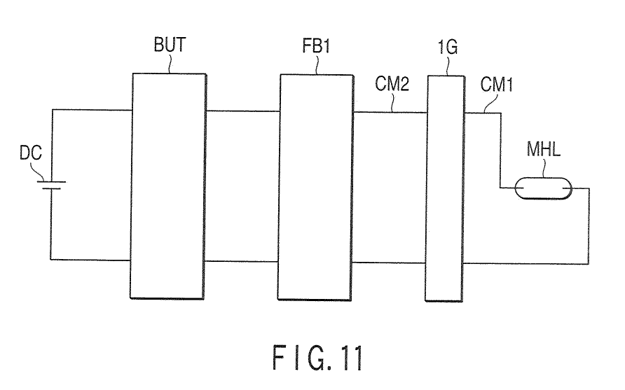

FIG. 11 is a block circuit diagram showing a fourth aspect for embodying this invention. In this aspect, a lighting main circuit OC is configured by a step-up chopper BUT and full-bridge inverter FBI, converts a DC current supplied from a DC power source DC to a rectangular low-frequency AC voltage, supplies the same to a high-pressure discharge lamp MHL and supplies such power source to a high-voltage pulse generator IG.

What is claimed is:

1. A high-pressure discharge lamp comprising:
a translucent airtight container having a discharging space in an internal portion,
electrode means for causing discharge in the discharging space of the translucent airtight container, and
an ionization medium sealed in the translucent airtight container and containing a metal halide and rare gas, the metal halide including at least one type of halides of thulium and holmium whose sealing ratio with respect to the total amount of sealed metal halides is not lower than 30 mass % and the rare gas being xenon at not lower than 3 atm at 25° C., and wherein mercury and a metal halide for formation of lamp voltage are not substantially contained in the translucent airtight container.

2. The high-pressure discharge lamp according to claim 1, wherein the ionization energy of one of the metal and metal halide for formation of lamp voltage is not less than 8 eV and the melting point thereof is not higher than 500° C.

3. The high-pressure discharge lamp according to claim 1, wherein the ionization medium contains at least one type of halides of thulium and holmium whose sealing ratio with respect to the total amount of metal halides is not lower than 50 mass %.

4. The high-pressure discharge lamp according to claim 1, wherein the ionization medium contains at least one type of halides of thulium and holmium whose sealing ratio with respect to the total amount of metal halides is not higher than 80 mass %.

5. The high-pressure discharge lamp according to claim 1, wherein the ionization medium contains xenon at not lower than 5 atm.

6. A lighting apparatus comprising:
a lighting apparatus main body,
a high-pressure discharge lamp described in any of claims 1 to 5 and arranged in the lighting apparatus main body, and
a lighting device that lights the high-pressure discharge lamp.

7. A high-pressure discharge lamp apparatus comprising:
a high-pressure discharge lamp described in claim 1,
a high-voltage pulse generator that generates a high-voltage pulse applied between a pair of electrodes of a luminous tube to start the high-pressure discharge lamp, and
a current conducting system that has a dielectric strength of not lower than 9 kV and connects the luminous tube of the high-pressure discharge lamp to the high-voltage pulse generator.

8. The high-pressure discharge lamp apparatus according to claim 7, wherein the high-pressure discharge lamp and the high-voltage pulse generator are separated by 60 to 500 mm when the rated lamp power of the high-pressure discharge lamp is 50 to 150 W, 80 to 500 mm when the rated lamp power is 150 to 400 W, and 130 to 500 mm when the rated lamp power is 400 to 1000 W.

9. The high-pressure discharge lamp apparatus according to claim 7, wherein the high-pressure discharge lamp and the high-voltage pulse generator are mechanically integrated.

10. The high-pressure discharge lamp apparatus according to claim 8, wherein the high-pressure discharge lamp and the high-voltage pulse generator are mechanically integrated.

11. The high-pressure discharge lamp apparatus according to any one of claims 7 to 10, wherein the high-pressure discharge lamp includes a base and the high-voltage pulse generator has a lamp socket integrally formed therewith to receive the base of the high-pressure discharge lamp.
